(19) United States
(12) Patent Application Publication
(10) Pub. No.: US 2008/0136961 A1
(43) Pub. Date: Jun. 12, 2008

(54) DEVICES AND METHODS FOR AN IMAGE RECORDING INDICATOR

(75) Inventors: RICK LATELLA, WOODSTOCK, IL (US); ROGER W. ADY, CHICAGO, IL (US); KEVIN W. JOHNSON, MUNDELEIN, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/609,619

(22) Filed: Dec. 12, 2006

(51) Int. Cl. H04N 5/225

(52) U.S. Cl. 348/376

(57) ABSTRACT

Disclosed are devices and methods for indicating operation of an imager by positioning a notification light within the no light zone that is between the imager and a lens and/or approximately in the same plane as the imager. The notification light can be configured to operate according to the duty cycle of the imager, that is, the light can be inactive while the imager is collecting light and can be active while the imager is not collecting light, without affecting the quality of the image capture or video recording. By positioning the notification light in the no light zone, there may be better utilization of the surface area of a camera or mobile communication device or other device with a camera.

### FIELD

Disclosed are electronic devices with an imager, and methods for electronic devices with an imager, and more particularly, devices and methods for indicating operation of the imager by positioning a notification light within a no light zone that is between the imager and a lens so that the notification light can be configured to operate according to a duty cycle of the imager.

### BACKGROUND

In certain jurisdictions, regulations require notification to a party being filmed or videotaped. Notification can be provided by illumination of a light on the camera during image capture. In general, many believe it is the public's right to be informed when their image is captured on a still or video camera. In particular, for still cameras or video recorders that do not look like traditional types, such as those of cellular telephones, the concern is more acute. Accordingly, still and video camera manufacturers may place indicator lights on the devices and in the same direction as the imager so that a would-be video subject may see the indicator light and know that their image is being recorded. However, the light from the indicator light may interfere with the quality of the image capture.

Still and video cameras are increasingly incorporated into mobile communication devices. The makers of mobile communication devices, including those of cellular telephones, are increasingly adding functionality to their devices. For example, cellular telephones having still and video cameras may include features such as video streaming and two-way video calling, as well as many new features. While there is a trend toward the inclusion of more features and improvements for current features, there is also a trend toward smaller mobile communication devices. As mobile communication device technology has continued to improve, the devices have become increasingly smaller. Therefore, there may less surface area for placement of components including the placement of the video recording indicator light as manufacturers continue to add features and reduce their products' size.

The area near the aperture of the still or video camera is referred to as a “no light zone.” So that the light does not interfere with the imager of the camera, a still or video camera indicator or notification light is placed outside of the no light zone. While the problem of light interference may be resolved by placing the notification light outside the no light zone, valuable surface area is occupied by the light. It would be beneficial to better utilize the surface area of the camera or mobile communication device having a camera.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts in side view an electronic device, and more particularly a mobile communication device including at least one camera, either a still camera or a video camera;

FIG. 2 illustrates that a camera may be on the front side of a cellular telephone;

FIG. 3 illustrates that a camera may be on the back side of a cellular telephone;

FIG. 4 illustrates a camera aperture through which an imager can sense light;

FIG. 5 depicts a side view of an imager to illustrate an embodiment of the placement of a notification light in a no light zone;

FIG. 6 depicts a front view similar to that of FIG. 4 except that a plurality of lights are positioned circumferentially to the imager and positioned within the no light zone;

FIG. 7 illustrates a camera activation button for a camera including an autofocus functionality;

FIG. 8 is a flowchart illustrating the activation of the notification light or lights within the no light zone during an autofocus operation;

FIG. 9 is a flowchart illustrating the deactivation of the notification light or lights during activation of the imager;

FIG. 10 depicts an embodiment of a circuit coupled to a controller and configured to activate light capture by the imager and to drive the illumination of the notification light or lights;

FIG. 11 depicts an embodiment of a circuit coupled to a controller and configured to activate light capture by the imager that may be covered by a shutter and in particular an electronic shutter and to drive the illumination of one or more lights;

FIG. 12 depicts an embodiment of a circuit coupled to a controller and configured to drive the light capture by the imager and/or drive a shutter, and a second circuit coupled to the controller and configured to drive the illumination of the light or lights;

FIG. 13 is a flow chart depicting an embodiment of a method described herein; and

FIG. 14 illustrates an illumination sequence of a plurality of lights similar to those shown forming a ring around the imager of FIG. 6.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Disclosed are devices and methods for indicating operation of an imager by positioning a notification light within the no light zone that is between the imager and the lens and/or approximately in the same plane as the imager. The notification light can be configured to operate according to the duty cycle of the imager, that is, the light can be inactive while the imager is collecting light and can be active while the imager is not collecting light, without affecting the quality of the image capture or video recording. By positioning the notification light in the no light zone, there may be better utilization of the surface area of the camera or mobile communication device or other device with a camera.

More particularly, disclosed are electronic devices including a controller and a camera coupled to the controller and defining an aperture, the camera including an imager operable in accordance with a duty cycle, the camera further including a lens, with a no light zone located between the imager and the lens. A light can be adjacent the aperture and under the lens in the no light zone. The light can be configured to operate according to the duty cycle so that the light can be inactive while the imager is collecting light and can be active while the imager is not collecting light.

In another embodiment, an electronic device includes a controller and a camera coupled to the controller and defining an aperture, the camera including an imager defining an imager plane, the imager operable according to a duty cycle. A light can be adjacent the aperture, approximately in the plane of the imager. The light can be configured to operate according to the duty cycle of the imager so that the light can be inactive while the imager collects light and can be active while the imager does not collect light. In this manner illumination of the notification light may not affect the quality of the image capture of video recording and use of valuable surface area of the device may be reduced.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims. It is understood that the use of relational terms, if any, such as first and second, up and down, and the like are used solely to distinguish one from another entity or action without necessarily requiring or implying any actual such relationship or order between such entities or actions.

At least some inventive functionality and inventive principles may be implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

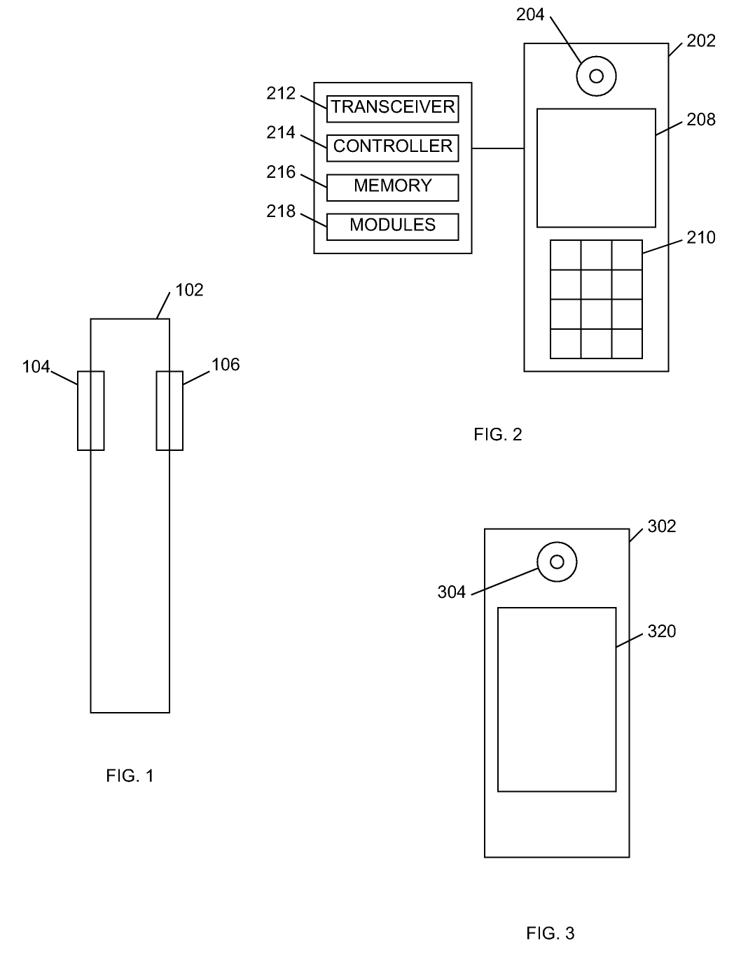

FIG. 1 depicts in side view an electronic device, and more particularly a mobile communication device 102 including at least one camera 104, either a still camera or a video camera. The described notification light may be utilized in any electronic device having a still camera or a video camera. When a still camera or video camera is incorporate into a device that is not traditionally a camera, such as a mobile communication device, the notification light increases the awareness of the subject that the subject's image is being captured.

The electronic device, and more particularly a mobile communication device 102, may be implemented as a cellular telephone (also called a mobile phone). One or more cameras, 104 and 106 may be positioned in any suitable location. The side view of the electronic device 102 depicts a first camera 104 on one side or the front side of the device 102 and a second camera 106 on another side or the back side of the device 102.

The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP). It is understood that the electronic device 102 described herein can be any type of electronic device including but not limited to a stand alone camera, and that a mobile communication device is discussed by way of an example of an electronic device.

FIG. 2 illustrates that camera 204 may be on the front side of a cellular telephone 202. The camera 204 may point away from the front of the device. A mobile communication device 202 may have any number of form factors. Popular are slider phones, clam shell phones, rotator phones and candy bar phones. The form factor may be a determining factor in where the camera is located on the electronic device. The device 202 may further include a display 208 and a keypad 210.

In a mobile communication device, to transmit and receive images, the device 202 can include a transceiver 212. The device 202 further includes a processor or controller 214 and memory 216. In conjunction with the processor 212, the modules 218 can carry out certain processes of the methods as described below. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation.

FIG. 3 illustrates that camera 304 may be on the back side of a cellular telephone 302. The camera 304 may point away from the back of the device and is depicted in a position above the battery pack 320. In this manner, when taking a still photograph or video recording, the user may view on the display 208 (see FIG. 2) a digitally reproduced image of the user's object, much like the view screen of a stand alone digital camera. As mentioned, an electronic device such as mobile communication device may have one, two or more cameras. Moreover, a mobile communication device may have two display screens as well so that the digitally reproduced image of the user's object may be viewed on either display screen depending upon the position of the camera on the device.

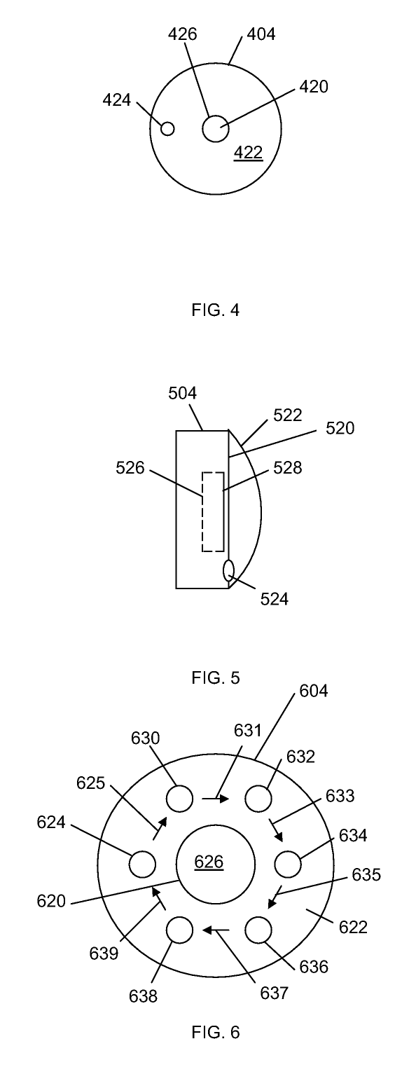

FIG. 4 illustrates a camera 404 aperture 420 through which an imager (526, see FIG. 5) can sense light. An imager can capture images digitally. However, a still or motion camera that may utilize film or tape is within the scope of this discussion as well. The imager may operate according to a duty cycle, sensing light at particular intervals to build a sequence of frames. Depending upon the resolution of the imager, frames may be captured at a rate of 5 to 30 frames per second for example. A typical duty cycle is 50%, meaning that the imager is ON and OFF at equal intervals, but different interval lengths or variations in interval lengths are also possible. When a sequence of motion picture frames is displayed at a sufficiently high temporal frequency, a human observer does not detect flicker but instead integrates the sequence of frames to perceive the effect of images in smooth motion.

The camera 404 can include a lens 422 that covers the aperture or the imager. The lens can have any shape. The lend 422 may define a “no light zone” where a light emanating from that area can interfere with the light capture of the imager. A light 424 is places within the no light zone behind the lend 422. The light may be an LCD or any other type of light. The color, such as white, may be a matter of preference.

As mentioned above, the imager 426 behind or colloctated with the aperture 420 may operate according to a duty scale, sensing light at particular intervals to build a sequence of frames. As with a sequence of motion picture frames that is displayed at a sufficiently high temporal frequency so that a human observer integrates the sequence of frames to perceive the effect of images in smooth motion, the notification light 424 turning OFF and ON at that same frequency may be perceived by an observer as continuously on. Therefore, the light 424 within the no light zone may be illuminated when the imager 426 is off and may be turned off when the imager 426 is on. Accordingly the light 424 is configured to operate according to the duty cycle of the imager 426 so that the light 424 is inactive while the imager 426 is collecting light and active while the imager 426 is not collecting light. By coupling a duty cycle for frame capture by a video camera 404 to operation of a light 424 that is in the no light zone adjacent the camera 404 to avoid light interference, the notification light 424 may not take up surface area beyond the no light zone, freeing that surface area for other elements or components of the electronic device 102 (see FIG. 1).

FIG. 5 depicts a side view of an imager to illustrate an embodiment of the placement of a notification light 524 in the no flight zone. As previously mentioned, the camera 504 may be positioned, in any appropriate location on an electronic device. An aperture 520 may have an imager 526 collocated with it or behind it. The imager 526 may operate according to a duty cycle. A shutter 528 mechanical or electronic may be proximal the imager. Alternatively, the lens 522 may include an electronic shutter. A notification light 524 is depicted behind the lens 522. The notification light is further depicted adjacent the aperture 520, approximately in the plane of the imager 526.

FIG. 6 depicts a front view similar to that of FIG. 4 except that a plurality of lights 624, 630, 632, 634, 636 and 638 positioned circumferentially to the imager and positioned within the no light zone is shown. Between the lights are arrows 625, 631, 633, 635, 637 and 639. The arrows indicate a progression of illumination where one or more of the lights are lit at a time or sequentially.

Accordingly, in the embodiment of FIG. 6, the plurality of lights 624 and 630-638 is positioned circumferentially about the aperture 620 and configured to be illuminated in a sequence. In this embodiment, a marquis effect may be generated in accordance with the duty cycle of the imager 626. The intensity of the lights can vary. For example, the sequence can include a first light 624 illuminated at a first intensity and a second light 630 adjacent the first light 624 and illuminated at a second intensity less than the first intensity.

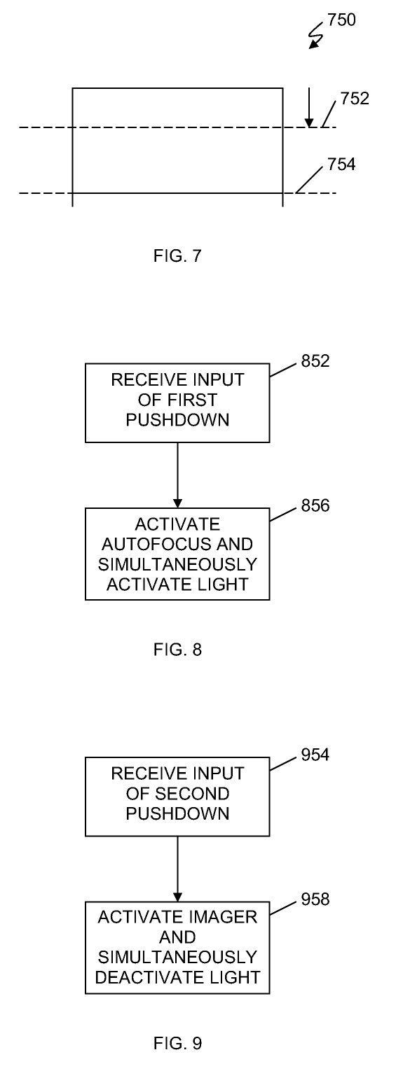

FIG. 7 illustrates a camera activation button 750 for a camera 104 (see FIG. 1) including an autofocus functionality. The activation button 750 can include a first pushdown position 752 which activates the autofocus functionality, and a second pushdown position 754 which activates capturing of an image by the camera 104. The activation button 750 can be configured so that the first pushdown position 752 is reached during depression of the activation button 750 before the second pushdown position 754 is reached. The light, for example similar to the light 424 (see FIG. 4) can be further configured to indicate activation of the camera 104 when the first pushdown position 752 is reached during depression of the activation button 750. The autofocus function may be initiated in both still and video image capture.

FIG. 8 is a flowchart illustrating the activation of the light or lights 424 (see FIGS. 4 and 6) within the no light zone during an autofocus operation. In this embodiment, the method of light activation can include receiving input of the first pushdown position 852 to activate the autofocus and simultaneously activate the light 856. In this arrangement, the light or lights 424 can be illuminated before the image capture.

FIG. 9 is a flowchart illustrating the deactivation of the light or lights 424 (see FIGS. 4 and 6) during activation of the imager 426. When the depression of the activation button reaches the second position 754 (see FIG. 7) device can receive input of the second pushdown 95. For a still camera, there can a deactivation of the notification light or lights 958 since the light 424 (see FIG. 4) may interfere with an image capture. During video recording, the notification light or lights 424 can be activated in between frames in accordance with the duty cycle of the imager 426 or shutter 428 so that light interference with video image capture by the notification light 424 may be avoided.

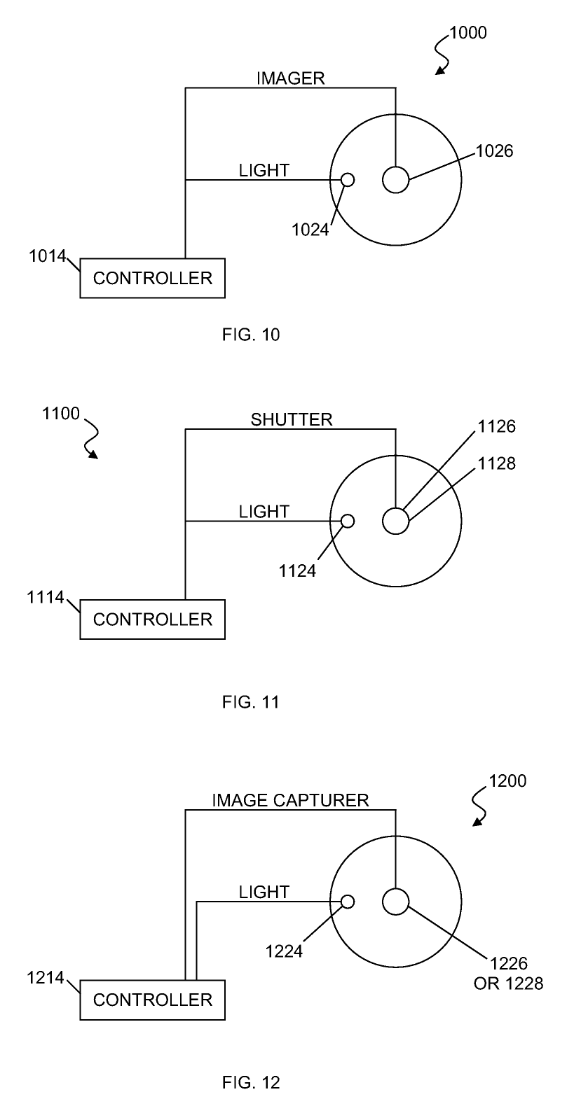

FIGS. 10, 11 and 12 depict three different circuit embodiments for driving the light or lights 424, 524 and 624-638 (see FIGS. 4, 5 and 6). FIG. 10 depicts an embodiment of a circuit 1000 coupled to the controller 1014 and configured to activate light capture by the imager 1026, and to drive the illumination of the light 1024. As discussed above, light capture by the imager 1026 can operate in accordance with a duty cycle, activating and deactivating the imager 1026 to build a sequence of images. A light 1024 driven by the same circuit as the imager 1026 may be deactivated when the imager 1026 is activated, and activated when the imager 1026 is deactivated. In this manner, the light 1024 can be in the no light zone and may not interfere with the capture of light by the imager 1026. As with the frames captured by the imager 1026, a human observer may not detect flicker of the light 1024 but instead integrate the sequence of the activated light 1024 or lights 624-638 (see FIG. 6) to perceive the effect of an always on light.

FIG. 11 depicts an embodiment of a circuit 1100 coupled to the controller 1114 and configured to activate light capture by the imager 1126 that may be covered by a shutter and in particular an electronic shutter 1128, and to drive the illumination of one or more lights 1124. The shutter can operate in accordance with a duty cycle so that the imager 1026 (see FIG. 10) can build a sequence of images. A light 1124 driven by the same circuit as the shutter 1128 may be activated in accordance with the duty cycle. In this manner, the light 1124 can be in the no light zone and may not interfere with the capture of light by the imager 1026.

FIG. 12 depicts an embodiment of a circuit 1200 coupled to the controller 1214 and configured to drive the light capture by the imager 1226 and/or a shutter 1228, and a second circuit coupled to the controller 1214 and configured to drive the illumination of the light 1224. That is, the circuit elements to drive the capture of images and to drive one or more lights 1224 are separate. The duty cycle of the imager 1226 or shutter 1228 may be a different speed than the duty cycle of the light or lights 1214.

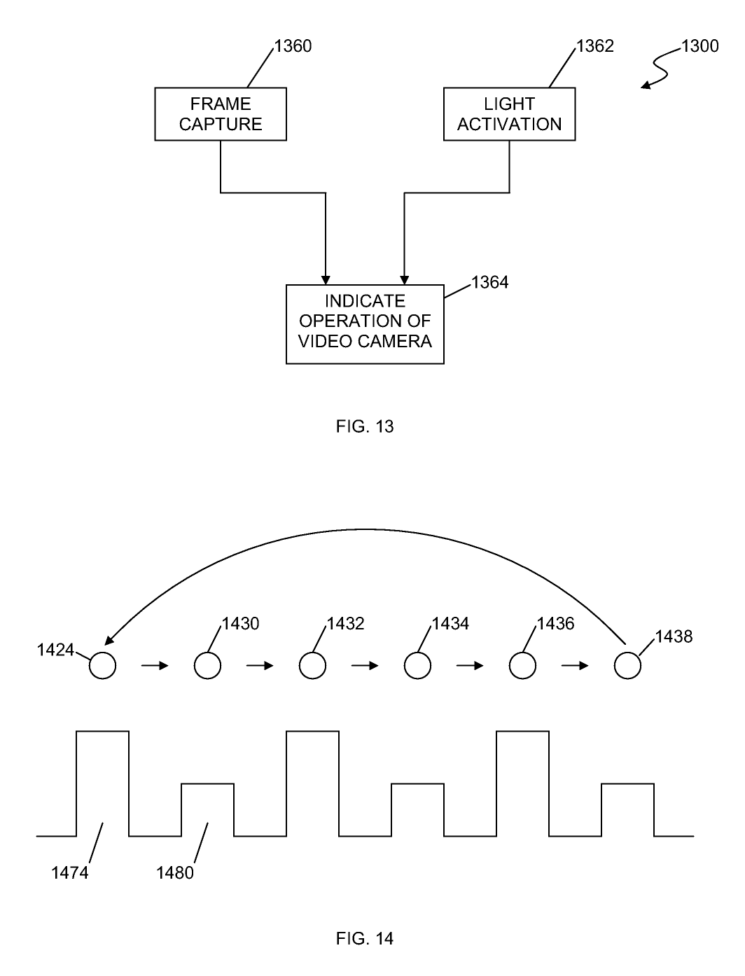

FIG. 13 is a flow chart depicted an embodiment of a method 1300 described above. The frame capture 1360 and the light activation may operate in accordance with the same duty cycle. In so doing, there may be an indication of the operation of a video camera 1364 by a light 424 (see FIG. 4) or plurality of lights 624-638 that are in the no light zone in close proximity to the imager, either behind the lens, or in the same plane as the imager, without interfering with the operation of the imager 424.

FIG. 14 illustrates a sequence or plurality of lights 1424-1438, similar to those shown forming a ring around the imager 626 (see FIG. 6). The plurality of lights may be in any arrangement, and may operate in any sequence of intensity. For example, to save power, the sequence includes a first light 1424 illuminated at a first intensity 1474 and a second light 1430 adjacent the first light 1424 and illuminated at a second intensity 1480 less than the first intensity 1474. A flashing marquis effect may be possible with a sequence of changing intensity that can include any number of intensities in the sequence.

The disclosed devices and methods for positioning a notification light within the no light zone that is between the imager and the lens or approximately in the same plane as the imager may better utilize the surface area of the camera or mobile communication device or other device with a camera. Where the notification light is configured to operate according to the duty cycle of the imager, the light can be inactive while the imager is collecting light and can be active while the imager is not collecting light, without affecting the quality of the image capture or video recording.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. An electronic device, comprising:
a controller;
a camera coupled to the controller and defining an aperture, the camera including an imager operable in accordance with a duty cycle, the camera further including a lens, with a no light zone located between the imager and the lens; and
a light adjacent the aperture and under the lens in the no light zone;
wherein the light is configured to operate according to the duty cycle so that the light is inactive while the imager is collecting light and active while the imager is not collecting light.

2. The device of claim 1, wherein the light comprises a plurality of lights.

3. The device of claim 2, wherein the plurality of lights is positioned circumferentially about the aperture and configured to be illuminated in a sequence.

4. The device of claim 3, wherein the sequence includes a first light illuminated at a first intensity and a second light adjacent the first light and illuminated at a second intensity less than the first intensity.

5. The device of claim 1, further comprising:
a camera activation button including an autofocus functionality;
wherein:
the activation button includes a first pushdown position which activates the autofocus functionality, and a second pushdown position which activates capturing of an image by the camera, the activation button configured so that the first pushdown position is reached during depression of the activation button before the second pushdown position is reached; and
the light is further configured to indicate activation of the camera when the first pushdown position is reached during depression of the activation button.

6. The device of claim 1, wherein the camera comprises a still camera.

7. The device of claim 1, wherein the camera comprises a video camera.

8. The device of claim 1, further comprising an electronic shutter and a circuit coupled to the controller and configured to drive the electronic shutter, and to drive the illumination of the light.

9. The device of claim 1, further comprising a circuit coupled to the controller and configured to activate light capture by the imager, and to drive the illumination of the light.

10. The device of claim 1, further comprising a first circuit coupled to the controller and configured to drive the light capture by the imager, and a second circuit coupled to the controller and configured to drive the illumination of the light.

11. The device of claim 1, wherein the light comprises at least one white LED.

12. An electronic device, comprising:
a controller;
a camera coupled to the controller and defining an aperture, the camera including an imager defining an imager plane, the imager operable according to a duty cycle; and
a light adjacent the aperture, approximately in the plane of the imager;
wherein the light is configured to operate according to the duty cycle coupled imager so that the light is inactive while the imager collects light and active while the imager does not collect light.

13. The device of claim 12, wherein the light comprises a plurality of lights.

14. The device of claim 13, wherein the plurality of lights is positioned circumferentially about the aperture and configured to be illuminated in a sequence.

15. The device of claim 14, wherein the sequence includes a first light illuminated at a first intensity and a second light adjacent the first light and illuminated at a second intensity less than the first intensity.

16. The device of claim 12, further comprising:
a camera activation button including an autofocus functionality;
wherein:
the activation button includes a first pushdown position which activates the autofocus functionality, and a second pushdown position which activates capturing of an image by the camera, the activation button configured so that the first pushdown position is reached during depression of the activation button before the second pushdown position is reached; and
the light is further configured to indicate activation of the camera when the first pushdown position is reached during depression of the activation button.

17. The device of claim 12, wherein the camera comprises a still camera.

18. The device of claim 12, wherein the camera comprises a video camera.

19. A method of an electronic device including a video camera, the method comprising:
coupling a duty cycle for frame capture by the video camera to operation of a light adjacent the camera; and
indicating operation of the video camera by operating the light according to the duty cycle so that the light is inactive during frame capture and active when no frame is being captured.

20. The method of claim 19, wherein the light comprises a plurality of lights and operating the light comprises:
illuminating the lights of the plurality of lights in a sequence.

21. The method of claim 20, wherein illuminating the lights of the plurality of lights comprises:
illuminating a first light at a first intensity; and
illuminating a second light adjacent the first light at a second intensity less than the first intensity.
